(19) United States
(12) Patent Application Publication
(10) Pub. No.: US 2025/0364815 A1
(43) Pub. Date: Nov. 27, 2025

(54) POWER SUPPLY CONTROL CIRCUIT AND CONTROL METHOD FOR PET WATER DISPENSER

(71) Applicant: Shenzhen Beibanqiu Network Technology Co., Ltd., Shenzhen (CN)

(72) Inventor: Zhu MING, Shenzhen (CN)

(73) Assignee: Shenzhen Beibanqiu Network Technology Co., Ltd., Shenzhen (CN)

(21) Appl. No.: 19/290,270

(22) Filed: Aug. 4, 2025

(30) Foreign Application Priority Data
Jun. 30, 2025 (CN) 202510897078.6

(51) Int. Cl. H02J 7/00

(52) U.S. Cl. CPC H02J 7/00041; H02J 7/0047; H02J 7/0063; H02J 7/0068; H02J 7/007182

(57) ABSTRACT

A power supply control circuit for a pet water dispenser is provided, wherein a charging management module is configured to output a charging current to a storage battery when a power input module supplies power, and control a charging current through a charging current signal output by a voltage division control module. A control terminal of a main control module controls the charging current signal output by the voltage division control module according to working states of the drive unit. The present invention has the advantages of preferentially guaranteeing the response speed of load power supply in the case where the battery is in a low-power state, dynamically adjusting the charging current to prevent system overload, improving the power adaptation capability in simultaneous charging and operation scenarios, and enhancing the charging stability when an external power source fluctuates.

### RELATED APPLICATIONS

The present patent document claims the benefit of priority to patent application No. 202510897078.6, filed Jun. 30, 2025, and entitled “POWER SUPPLY CONTROL CIRCUIT AND CONTROL METHOD FOR PET WATER DISPENSER,” the entire contents of each of which are incorporated herein by reference.

### BACKGROUND

### 1. Technical Field

The present invention relates the technical field of control circuits, and in particularly to a power supply control circuit for a pet water dispenser.

### 2. Background Information

Currently, pet water dispensers are widely used in households, pet stores, and pet hospitals to provide automatic supply of daily drinking water for pets. The pet water dispensers are typically equipped with rechargeable lithium batteries as backup power sources, along with charging control circuits to achieve cyclic charging of the batteries and stable power supply to loads such as a water pump.

However, most of the existing pet water dispensers do not effectively optimize the emergency water supply demand in the case where the battery is in a low-power state. Common schemes usually preferentially employ external power sources to charge the lithium batteries, and the water pump is driven to work after the lithium batteries have been recharged with a certain amount of electricity. This results in a significant startup delay when the device is initially powered on, especially when users urgently need to use the water drinking function, leading to poor user experiences.

Furthermore, in order to achieve a function of simultaneous charging and operation, some existing pet water dispensers attempt to accommodate both load operations and battery charging by improving the adapter powers (e.g., 5V/2A), which not only raises costs but also imposes higher demands on the adapters and power supply lines. Therefore, there is an urgent need for a power supply control scheme for a pet water dispenser that can flexibly adjust charging currents according to load states, accommodate low-cost adapter specifications, and achieve simultaneous charging and operation capabilities.

### BRIEF SUMMARY

In view of the defects and shortcomings of the existing technology, the purpose of the present invention is to provide a power supply control circuit and method for a pet water dispenser, which has the advantages of preferentially guaranteeing the response speed of load power supply in the case where the battery is in the low-power state, dynamically adjusting the charging current to prevent system overload, improving the power adaption compatibility in simultaneous charging and operation scenarios, and enhancing the charging stability when an external power source fluctuates.

The present invention provides a power supply control circuit. The technical scheme is as follows:

A power supply control circuit for a pet water dispenser comprises: a power input module, a charging management module, a voltage division control module, a main control module, a drive unit, and a storage battery. The power input module is connected to both the charging management module and the voltage division control module, a charging current setting terminal of the charging management module is connected to ground through the voltage division control module, the charging management module is connected to both the drive unit and the storage battery, the drive unit is connected to the storage battery, and the main control module is connected to both the voltage division control module and the drive unit. The charging management module is configured to output a charging current to the storage battery when the power input module supplies power, and control the charging current through a charging current signal output by the voltage division control module.

A control terminal of the main control module controls the charging current signal output by the voltage division control module according to working states of the drive unit.

Further, the voltage division control module includes a resistance R3, a resistance R4, a resistance R5, a resistance R6, a resistance R7, a first switch tube and a second switch tube. The first switch tube and the second switch tube are transistors; the power supply input module is connected to both a current input terminal of the first switch tube and a control terminal of the second switch tube through the resistance R3. A current output terminal of the first switch tube is connected to ground, a control terminal of the first switch tube is connected to ground through the resistance R6 and connected to the control terminal of the main control module through the resistance R7, and a current output terminal of the second switch tube is connected to ground. A current input terminal of the second switch tube is connected to one end of the resistance R5, the other end of the resistance R5 is connected to the charging current setting terminal of the charging management module and connected to ground through the resistance R4.

The control terminal of the main control module outputs a first control signal or a second control signal according to the working states of the drive unit.

Further, the control signal is the first control signal when the drive unit is in a working state, and the second control signal when the drive unit is not in the working state. The first control signal has a high-level, and the second control signal has a low-level.

Further, the charging management module includes a resistance R1, a charging management chip U1, and a third switch tube Q1. The third switch tube Q1 is a MOS transistor, an enable terminal of the charging management chip U1 is connected to a gate electrode of the third switch tube Q1 through the resistance R1, a source electrode of the third switch tube Q1 is connected to a positive electrode of the storage battery and a battery positive connection terminal of the charging management chip U1, and a drain electrode of the third switch tube Q1 is connected to the drive unit.

Further, the present invention further comprises a display module. The display module is configured to display charging states, the charging management module includes a resistance R2, and a charging state indication terminal of the charging management chip U1 is connected to the display module through the resistance R2.

Further, the power input module includes a resistance R8, a capacitor C1, and a power input terminal VIN. The power input terminal VIN is connected to ground through the resistance R8 and the capacitor C1, respectively.

Further, the present invention further comprises a voltage detection module, and the voltage detection module is configured to collect voltages of the power input terminal VIN. The voltage detection module includes a resistance R9, a resistance R10, and a capacitor C3. The resistance R9 and the resistance R10 are connected in series, the resistance R9 is connected to the power input terminal VIN, and the resistance R10 is connected to ground. One terminal of the capacitor C3 is connected to a connection node VIN_AD between the resistance R9 and the resistance R10, and the other terminal is connected to ground, the connection node VIN_AD is connected to a voltage detection terminal of the main control module. The main control module is configured to judge a voltage state of the power input terminal VIN according to the voltage signal output by the voltage detection module, and control the voltage division control module so as to regulate the charging current.

Further, the present invention further proposes a power supply control method for a pet water dispenser, which applies the above power supply control circuit for the pet water dispenser, comprising:
acquiring a voltage state of a lithium battery and a connection state of an external power source;
judging whether it is currently in a charging mode according to the voltage state and the connection state of the external power source, and determining a corresponding operation mode, wherein the operation mode includes a load power supply priority mode or a battery charging priority mode; and
regulating a charging current according to the operation mode.

Further, acquiring the voltage state of the lithium storage battery and the connection state of the external power source specifically includes:
acquiring a current terminal voltage value of the lithium battery and comparing the terminal voltage value with a preset voltage threshold range;
when the terminal voltage value is lower than a first threshold, determining that it is currently in a low-battery state, and entering a forced charging mode;
when the terminal voltage value is between the first threshold and a second threshold, determining that it is currently in a buffer state for simultaneous charging and operation, and entering a control mode that accommodates both load power supply and battery replenishment;
when the terminal voltage value is higher than the second threshold, determining that the battery has sufficient charge, pausing or reducing the charging current, and entering a voltage maintenance state;
collecting an input voltage of a power input terminal and comparing it with a reference voltage value;
when the input voltage is greater than the reference voltage value, judging that the power input is normal, and entering a charging state; and
when the input voltage is lower than the reference voltage value or a power interruption is detected, terminating a charging process, and switching to a battery powered state.
regulating the charging current according to the operation mode specifically includes:
acquiring a working state signal of a drive unit, wherein the working state signal reflects whether a current load module is in an active state;
when the drive unit is detected to be in the active state, generating a first control signal to regulate a charging current control terminal of the charging management module so as to lower the charging current; and
when the drive unit is detected to be in an inactive state, generating a second control signal to switch to a maximum charging current configuration;
wherein a dynamic adjustment process of the charging current is further based on a real-time detection result of the voltage of the external power source, when the voltage of the external power source is lower than a preset reference value, the charging current is limited below a safety threshold.

It can be seen from the above, a power supply control circuit and control method for a pet water dispenser provided in the present invention employs the main control module to dynamically control the charging current signal output by the voltage division control module according to working states of the drive unit, thus to achieve intelligent matching of the charging current and the load power supply demand. In the low-power state, the response speed of the load power supply is preferentially guaranteed, and the charging parameters are adjusted in real time according to the voltage fluctuations of the external power source, which has the advantages of improving the stability and safety of the system.

### BRIEF DESCRIPTION OF THE DRAWINGS

In order to more clearly illustrate the technical schemes in the embodiments or existing technology of the present invention, accompanying drawings that need to be used in the embodiments or existing technology are briefly described hereafter. It is obvious that the accompanying drawings in following description are merely some embodiments of the present invention, and for those who skilled in the art, other accompanying drawings may be obtained based on these accompanying drawings without exerting creative efforts.

FIG. 1 is a structural block diagram of a power supply control circuit for a pet water dispenser according to an embodiment of the present invention.

FIG. 2 is a circuit diagram of a voltage division control module according to the embodiment of the present invention.

FIG. 3 is a circuit diagram of a charging management module, a power input module and a drive module according to the embodiment of the present invention.

FIG. 4 is a circuit diagram of a voltage detection module according to the embodiment of the present invention.

FIG. 5 is a flow chart of a power supply control method for a pet water dispenser provided by the embodiment of the present invention.

The reference numerals are as follows:

power input module 100, charging management module 200, voltage division control module 300, main control module 400, drive unit 500, storage battery 600, voltage detection module 700.

### DETAILED DESCRIPTION OF THE DRAWINGS AND THE PRESENTLY PREFERRED EMBODIMENTS

The present invention will be further illustrated below in conjunction with the drawings.

This specific embodiment is provided solely to illustrate the present invention and does not limit to the scope of the present invention. Persons skilled in the art may make modifications to this embodiment as needed without creative contributions after reading the present specification, and all such modifications falling within the scope of the claims shall be protected under the Patent Law.

To make the purposes, technical schemes and advantages of the embodiments of the present invention clearer, the technical schemes in the embodiments of the present invention will be clearly and completely described below in conjunction with the accompanying drawings in the embodiments of the present invention. Apparently, the described embodiments are merely a part of the embodiments of the present invention, but not all of the embodiments. Typically, the components of the embodiments of the present invention described and shown in the accompanying drawings here can be arranged and designed in various configurations.

Therefore, the detailed descriptions of the embodiments of the present invention provided in the drawings is not intended to limit the scope of the present invention, but merely to represent selected embodiments of the present invention. Based on the embodiments of the present invention, all other embodiments obtained by those of ordinary skill in the art without exerting creative efforts belong to the protection scope of the present invention.

In existing technology, pet water dispensers commonly employ lithium batteries as backup power sources, achieving battery cycle charging and load power supply through the charging control circuits. The conventional scheme preferentially charges the battery when an external power source is connected, after the battery is charged to reach a certain amount of power, a water pump is allowed to start, which results in that users cannot immediately use the water drinking function when the device is initially powered on. Some of the improved schemes attempt to employ high-power adapters to satisfy both charging and load operation demands at the same time, but this increases equipment costs and circuit load pressure.

In order to solve the above problems, it is necessary to design a power supply control scheme that can dynamically adjust charging current according to a real-time state of the load. When the water pump is in the working state, the system shall reduce the charging current to preferentially guarantee the load power supply; when the pump stops working, the system shall restore a maximum charging current to enhance replenishment efficiency. This dynamic adjustment mechanism can achieve linkage control between the charging current and the load state through innovative circuit structure, thereby overcoming the defects of conventional schemes where charging and power supply mutually constrain each other.

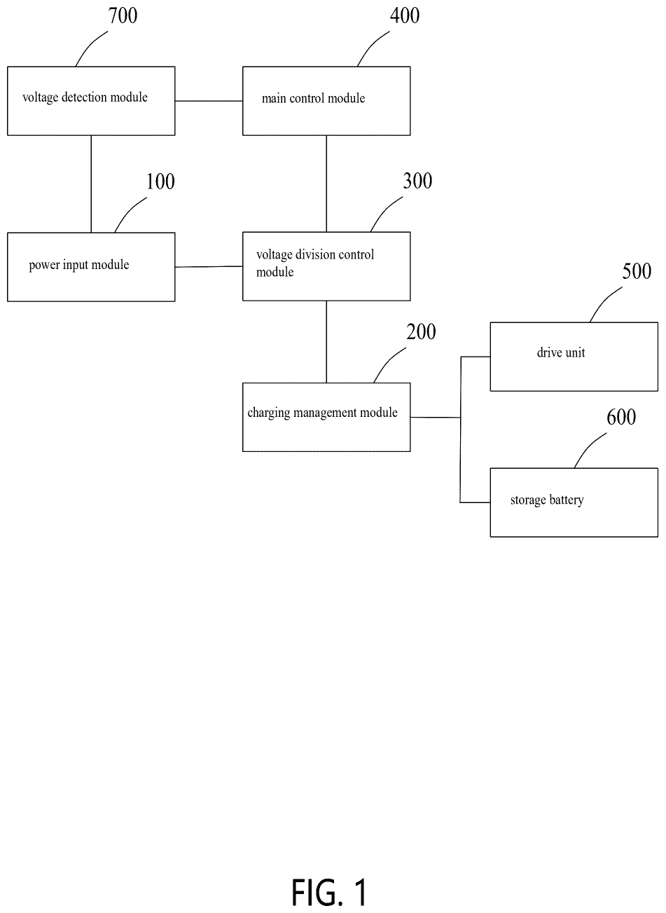

Referring to FIG. 1, the present invention proposes a power supply control circuit comprising a power input module 100, a charging management module 200, a voltage division control module 300, a main control module 400, a drive unit 500, and a storage battery 600. The power input module 100 is connected to both the charging management module 200 and the voltage division control module 300, a charging current setting terminal of the charging management module 200 is connected to ground through the voltage division control module 300, the charging management module 200 is connected to the drive unit 500 and the storage battery 600, the drive unit 500 is connected to the storage battery 600, and the main control module 400 is connected to the voltage division control module 300 and the drive unit 500. The charging management module 200 outputs a charging current to the storage battery 600 when the power input module 100 supplies power, and control the charging current through a charging current signal output by the voltage division control module 300. The main control module 400 controls the output of the charging current signal from the voltage division control module 300 according to working states of the drive unit 500.

The power input module refers to a circuit unit that converts an external AC or DC power into a stable DC voltage. Specifically, it can be achieved by adopting a combination of a rectifier filter circuit and a voltage conversion chip, for providing fundamental power supply to the system.

The charging management module refers to an integrated circuit unit that controls a charging process of the storage battery, and it can be specifically achieve by adopting a special chip with constant current constant voltage charging function, which is responsible for adjusting the charging current according to a voltage division control signal. The voltage division control module refers to an adjustment circuit that generates a variable voltage signal, and it can be specially achieved by adopting a combination of a resistance network and a transistor switch, where charging current setting signals of different levels are generated by changing equivalent resistance values. The main control module refers to a microcontroller unit with logic judgment function, and it can be specially achieved by adopting a single-chip microcomputer or a programmable logic device, for collecting the state of the drive unit and outputting a corresponding voltage division control instruction. The drive unit refers to a power output circuit that controls water pump operation, it can be specially achieved by adopting a MOS tube or a relay drive circuit, and its working current state reflects start-stop information of the load.

During specific operation, when the external power source is connected, the charging management module starts to output the charging current to the storage battery. The main control module continuously monitors the operation state of the driving unit: if the drive unit is in an operation state, the main control module sends an adjustment command to the voltage division control module, so that the voltage division control module outputs a voltage signal that reduces the charging current, and the charging management module accordingly reduces the charging current to ensure that the external power source is preferentially supplied to the water pump; if the drive unit is in a stop state, the main control module controls the voltage division control module to output a voltage signal that allows a maximum charging current, so that the charging management module charges the storage battery at a maximum rate. This dynamic adjustment mechanism enables the system to respond to the load demands immediately when the external power source supplies power, and optimize the charging efficiency based on the idle periods of the load.

Compared to the existing technology, in the conventional schemes, when the external power source is connected, the water pump is not allowed to start until the battery is fully charged. In contrast, in this scheme, the main control module monitors the load state in real time, allowing the water pump to start immediately during the charging process, thereby eliminating the startup delay after the device is energized. The existing technology needs to adopt high-power adapters to achieve the function of simultaneous charging and operation, whereas this scheme dynamically adjusts the charging current, so that ordinary adapters can meet dual demands of load power supply and battery charging.

Through the above technical scheme, the present invention achieves instantaneous startup of the load and intelligent adjustment of the charging current when the external power source supplies power, and solves the technical contradiction between charging and power supply in the conventional schemes. The present invention ensures the user to use the water drinking function at any time, optimizes the charging efficiency of the battery, reduces the power requirement of the adapters, and provides an effective circuit control scheme for achieving the function of simultaneous charging and operation at low costs.

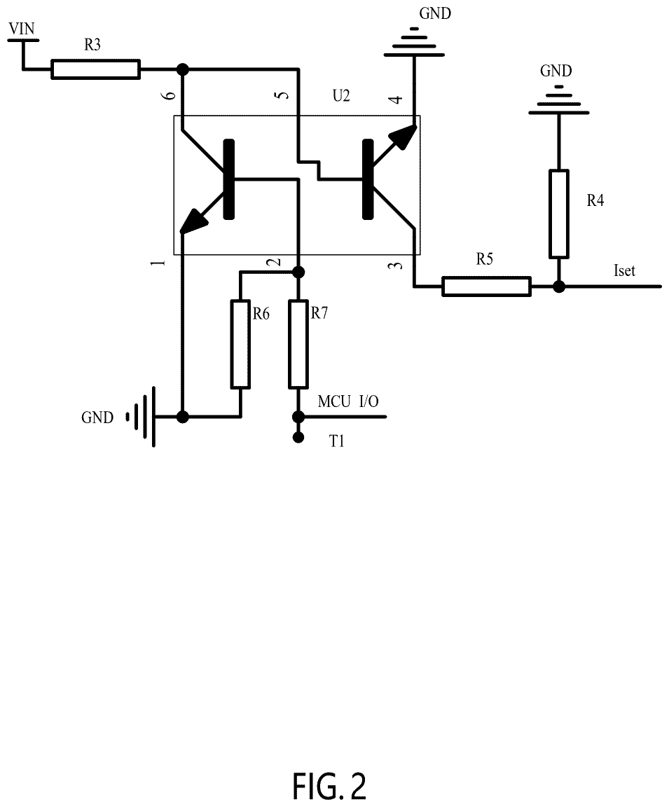

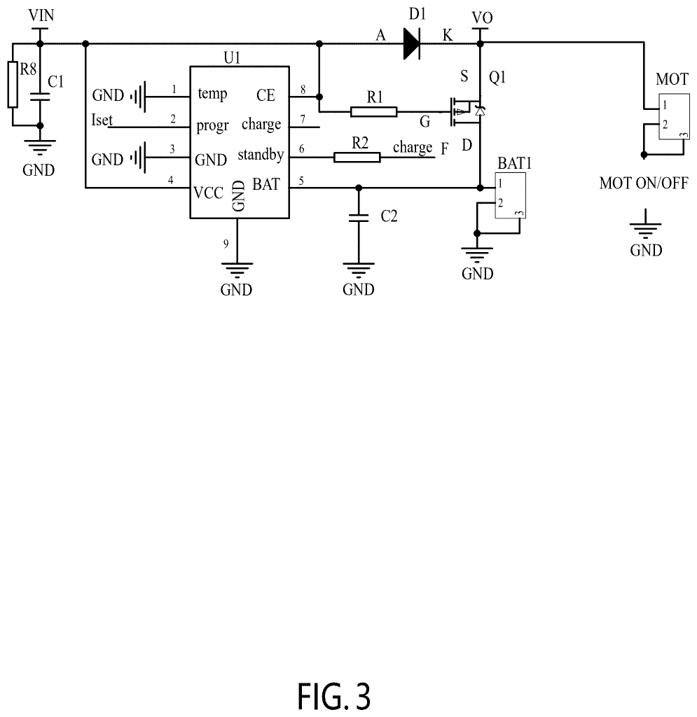

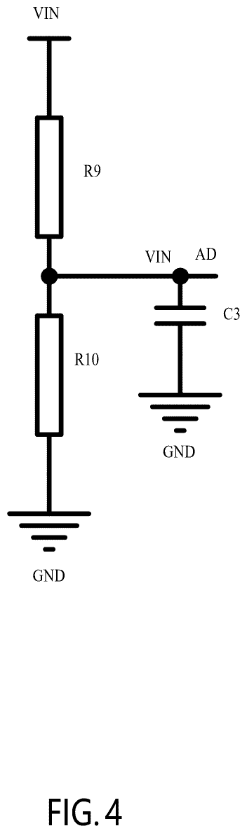

Referring to FIGS. 2-4, the present invention provides another power supply control circuit for the pet water dispenser in one possible implementation embodiment.

The present invention further proposes a power supply control circuit for a pet water dispenser. The voltage division control module includes a resistance R3, a resistance R4, a resistance R5, a resistance R6, a resistance R7, a first switch tube and a second switch tube. The first switch tube and the second switch tube are transistors. The power input module is connected to a current input terminal of the first switch tube and a control terminal of the second switch tube respectively through the resistance R3, a current output terminal of the first switch tube is connected to ground, and a control terminal of the first switch tube is connected to ground through the resistance R6 and connected to the control terminal of the main control module through the resistance R7. A current output terminal of the second switch tube is connected to ground, a current input terminal of the second switch tube is connected to one end of the resistance R5, and the other end of the resistance R5 is connected to a charging current setting terminal of the charging management module and is connected to ground through the resistance R4. The control terminal of the main control module outputs a first control signal or a second control signal according to the working states of the drive unit.

The voltage division control module refers to a circuit structure that forms an adjustable voltage dividing path through a combination of a resistance network and a switch tube. Specifically, transistors can be used as switching elements, wherein the main control module outputs high- or low-level signals to change a voltage divider ratio, thereby adjusting a voltage value at the charging current setting terminal. The first switch tube refers to a transistor used to receive the control signal of the main control module. Specifically, it can be an NPN bipolar transistor or an N-channel MOSFET, which is turned on or off after receiving the control signal through the resistance R7, thereby changing the potential at the control terminal of the second switch tube. The second switch tube refers to a transistor used to adjust a grounding path of the charging current setting terminal. Specifically, it can be a PNP bipolar transistor or a P-channel MOSFET, whose conduction degree is determined by the first switch tube; and then the current setting value of the charging management module is controlled by the voltage division relationship between the resistance R5 and the resistance R4.

In actual implementation, when the main control module detects that the drive unit is in the working state, a high-level signal is output to the control terminal of the first switch tube through the resistance R7, causing the first switch tube to conduct. At this time, a potential at the control terminal of the second switch tube is pulled down and conducted, and the charging current setting terminal then forms an equivalent voltage divider resistance through the parallel connection of the resistance R5 and the resistance R4, thereby reducing a charging current setting value of the charging management module. When the drive unit is not in the working state, the main control module outputs a low-level signal to cut off the first switch tube, and the potential at the control terminal of the second switch tube is raised and closed, and the charging current setting terminal is connected to ground only through the resistance R4. At this time, the voltage divider resistance value is reduced at this time, and the charging management module charges the storage battery with the maximum charging current.

Preferably, the first switch tube and the second switch tube can be replaced by a dual NPN transistor integrated chip, or replaced by other components with the same or similar functions.

The present invention further proposes that, the control signal is the first control signal when the drive unit is in the working state, and the second control signal when the drive unit is not in the working state. The first control signal has a high-level, and the second control signal has a low-level.

The first control signal refers to a logic level signal output by the main control module when the drive unit is detected to be in the working state. Specifically, it can be achieved by on or off states of the transistor, and the charging current can be adjusted by pulling the high-level to trigger the voltage division control module. The second control signal refers to a logic level signal output by the main control module when the drive unit is not in the working. Specifically, it can be achieved by adopting a pull-down resistor or the off-state of the switching transistor, and the charging current configuration can be switched through the low-level. The high-level refers that a signal voltage reaches a threshold range of logic 1, such as a voltage value of 3.3V or 5V. The low-level refers that a signal voltage is lower than a threshold range of logic 0, such as 0V or close to a ground potential. The working state of the drive unit refers to whether the load module such as a water pump or a motor is in an energized state, and it can be detected by a current sensor or a switching signal.

In actual implementation, when the drive unit is in the working state, the main control module outputs the first control signal of the high-level to a connection terminal of the resistance R7 of the voltage division control module to turn on the first switch tube and change the equivalent resistance value of the voltage dividing network, thereby reducing the voltage at the charging current setting terminal of the charging management module and achieving dynamic reduction of the charging current. When the drive unit stops working, the main control module outputs the second control signal of the low-level to cut off the first switch tube, the voltage dividing network restores to original resistance configuration, the voltage at the charging current setting terminal rises, and the charging management module switches to a maximum charging current mode. Therefore, the adjustment process of the charging current is linked with the load operational state in real time to ensure that the external power source preferentially meets the load power supply demand.

The present invention further proposes that the charging management module includes a resistance R1, a charging management chip U1, and a third switch tube Q1. The third switch tube Q1 is a MOS transistor, an enable terminal of the charging management chip U1 is connected to a gate electrode of the third switch tube Q1 through the resistance R1, a source electrode of the third switch tube Q1 is connected to a positive electrode of the storage battery and a battery positive connection terminal of the charging management chip U1, and a drain electrode of the third switch tube Q1 is connected to the drive unit.

The charging management chip U1 refers to an integrated circuit with charging state management function, and it can be specially achieved by adopting special chips such as BQ24075, for generating a charging enable signal and controlling the charging current according to a state of the input power. The third switch tube Q1 refers to a metal-oxide-semiconductor field-effect transistor, and it can be specially achieved by adopting an N-channel MOS tube such as the AO3400, for turning on or off a power supply path between the storage battery and the drive unit according to an enable signal. The resistance R1 refers to a current limiting element, and it can be specially achieved by adopting a chip resistor with a resistance of 10kΩ, for limiting a drive current at the enabled terminal of the charging management chip.

In actual implementation, when the external power source is connected, the charging management chip U1 outputs a high-level from the enable terminal, and this signal is transmitted to a gate electrode of the third switch tube Q1 through the resistance R1 to make it turn on. At this time, the positive electrode of the battery supplies power to the drive unit through the turn-on third switch tube Q1. The charging management chip U1 continuously monitors the voltage state of the storage battery. When the storage battery is detected to be fully charged, an enable signal is automatically turned off, and the third switch tube Q1 is turned off accordingly to avoid overcharging. When the external power source is disconnected, the enable terminal of the charging management chip U1is maintained at a low-level, and the third switch tube Q1 is in the off state, and the battery supplies power to the drive unit through an independent discharge circuit.

The present invention further proposes a display module which is configured to display charging states. The charging management module includes a resistanceR2. A charging state indication terminal of the charging management chip U1 is connected to the display module through the resistance R2. The display module refers to an indicating device that provides visual feedback on the charging process of the storage battery, and it can be specifically achieved by adopting an LED array or LCD panel to convey the charging state information through the light flicker frequency of different colors or the text symbols. The resistance R2 is a current limiting component connected in series within a charging state indication signal path, and it can be specifically achieved by adopting a chip resistor or a carbon film resistor, for preventing overloading of the output port of the charging management chip.

During working, when the charging management chip U1 detects that the storage battery is in a constant current charging phase, its charging state indication terminal outputs a periodic pulse signal, and this signal, after being limited by the resistance R2, drives a green LED of the display module to blink at a frequency of 1 Hz. When the storage battery enters a constant voltage charging phase, the charging state indication terminal is switched to a continuous high-level, so that the green LED is turned into a bright state. If a charging abnormality is detected, the charging state indication terminal outputs a low-level signal to trigger a red LED of the display module to light up as an alarm. The main control module can synchronously update prompt information of the display module by monitoring the level variations of the charging state indication terminal.

This embodiment effectively solves the problem that the user cannot grasp the charging process of the pet water dispenser in real time, and prevents the overload risk of the signal transmission line through the current limiting protection of the resistance R2. The state feedback mechanism of the display module enables the device to provide the charging process information immediately after being connected to the power source, thereby eliminating operational confusions caused by the user's inability to judge the charging state in the conventional scheme.

The present invention further proposes a power input module, which includes a resistance R8, a capacitor C1, and a power input terminal VIN. The power input terminal VIN is connected to ground through the resistance R8 and the capacitor C1, respectively. The resistance R8 refers to a current limiting element connected in series between the power input terminal VIN and ground, and it can be specifically achieved by adopting a chip resistor with a resistance value of, for example, 100, for limiting abrupt change of an input current and reducing the impact of inrush current on back-end circuits during power-on transients. The capacitance C1 refers to a filter element in parallel between the power input terminal VIN and the ground, and it can be specially achieved by adopting an electrolytic capacitor with a capacitance of, for example, 100 μF, for absorbing high frequency noise at the power input terminal and smoothing the fluctuation of the input voltage, thereby improving the stability of the power input.

In actual implementation, when the power input terminal VIN is connected to an external adapter, the resistance R8 can limit peak values of the input current, thereby preventing overloading of the adapter or line overheating. Simultaneously, the capacitor C1 filters high-frequency interference signals such as adapter switching noise or ripple caused by grid fluctuation in the power source through charging and discharging. When the external power source is connected, the resistance R8 and the capacitance C1 work together, so that the voltages inputs to both the charging management module and the voltage division control module are more stable, thus to provide stable fundamental power supply for subsequent charging current regulation and load driving.

This embodiment addresses the risk of overloading of the adapter caused by the abrupt change of the current when the external power source is connected, and simultaneously reduces interference of input voltage fluctuation on the charging management module, so that the pet water dispenser can quickly enter a stable working state after the external power source is connected, and the function of simultaneous charging and operation can be achieved without relying on the high-power adapters, thereby reducing hardware costs for the entire system.

The present invention further proposes that a voltage detection module is provided in the power supply control circuit, and the voltage detection module is configured to collect voltages of the power input terminal VIN. The voltage detection module includes a resistance R9, a resistance R10, and a capacitor C3. The resistance R9 and the resistance R10 are connected in series, the resistance R9 is connected to the power input terminal VIN, and the resistance R10 is connected to ground. One terminal of the capacitor C3 is connected to a connection node VIN_AD between the resistance R9 and the resistance R10, and the other terminal is connected to ground. The connection node VIN_AD is connected to a voltage detection terminal of the main control module. The main control module is configured to judge a voltage state of the power input terminal VIN according to the voltage signal output by the voltage detection module, and control the voltage division control module so as to regulate the charging current.

It should be noted that the voltage detection module refers to convert a voltage at the power input terminal into a signal with a detectable range through the voltage dividing resistance network. Specifically, the resistance R9 and the resistance R10 can be connected in series to form a voltage division circuit. For example, the resistance R9 may have a resistance value of 10kΩ, and the resistance R10 may have a resistance value of 2kΩ, thereby proportionally reducing the input voltage to the detectable range of the main control module. The capacitor C3 is used to eliminate the high frequency noise in the voltage detection signal. Specifically, a 0.1 μF ceramic capacitor can be connected in parallel between the voltage dividing node and ground, thereby improving stability of voltage detection. The voltage detection terminal of the main control module refers to collecting a divided voltage signal through an analog-to-digital conversion channel. Specifically, it can be achieved by connecting an ADC pin of the microcontroller to a voltage division node VIN_AD, thereby monitoring the fluctuation of the input voltage in real time.

Specifically, when the power input terminal VIN is connected to the external adapter, the resistance R9 and the resistance R10 divide an input voltage to generate a detection signal, while the capacitor C3 filters out interference signals. The main control module reads a voltage value of the voltage dividing node VIN_AD through the voltage detection terminal, and determines whether the input power source is in a stable state according to preset voltage thresholds. For instance, when the input voltage is detected to be lower than the preset threshold, the main control module controls the voltage division control module to reduce the charging current, preventing charging abnormalities caused by insufficient input power. When the input voltage returns to normal levels, the main control module increases the charging current again to improve the charging efficiency.

This embodiment solves the problem that the charging current of the existing pet water dispenser cannot be adjusted adaptively when the output of the adapter is unstable, prevents charging failures or device shutdowns caused by input voltage drops, and reduces the requirement of adapter power specification, which enables stable simultaneous charging and operation even when low-cost adapters are used.

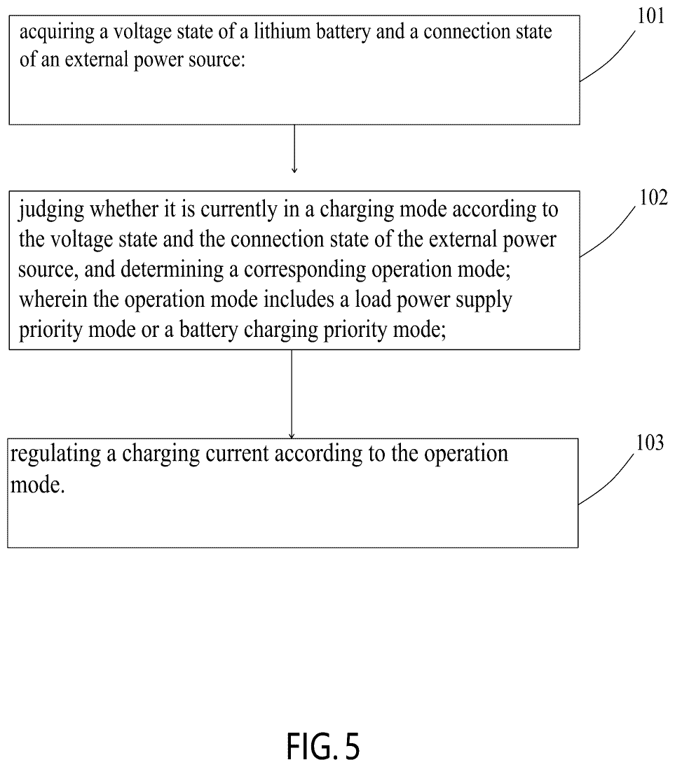

Referring to FIG. 5, the present invention further proposes a power supply control method for a pet water dispenser, which applies the power supply control circuit for the pet water dispenser as described above.

The method comprises:
acquiring a voltage state of a lithium battery and a connection state of an external power source;
judging whether it is currently in a charging mode according to the voltage state and the connection state of the external power source, and determining a corresponding operation mode, wherein the operation mode includes a load power supply priority mode or a battery charging priority mode; and
regulating a charging current according to the operation mode.

It should be noted that the voltage state of the lithium storage battery refers to a battery terminal voltage value collected by the voltage detection module, it can be achieved by adopting a voltage division circuit and an analog-to-digital converter, to determine whether the battery requires charging or should cease charging.

It should be noted that the connection state of the external power source refers to detect whether there is an effective input voltage at the power input terminal through the voltage comparison circuit, and it can be achieved by adopting a resistance voltage divider network and a reference voltage source to determine whether the external power source is enabled.

It should be noted that the operation mode refers to a dynamically selected charging strategy according to the battery voltage and the state of the external power source, and it can be achieved by a logic judgment of the main control module. When the external power source is connected and the battery level is low, the load is preferentially powered; when the battery voltage returns to a safe range, switching to the battery charging priority mode.

In some embodiments, when the external power source is connected, the main control module first detects the terminal voltage of the lithium storage battery. If the terminal voltage is lower than the preset threshold, it is judged to be a low power state. In this case, the main control module controls the charging management module to reduce the charging current, and preferentially allocates energy from the external power source to the drive unit to maintain water pump operation. If the terminal voltage is within the normal range, the charging management module is allowed to charge the storage battery with the maximum current. When the external power source is disconnected, the main control module immediately cuts off the charging circuit and switches to the battery powered mode. The regulation of the charging current is achieved by changing the equivalent resistance of the voltage division control module. For instance, when the load is enabled, the voltage value at the charging current setting terminal is reduced, thereby limiting the output current of the charging management chip.

The present embodiment solves the problem of start-up delay caused by priority charging when the existing pet water dispenser is connected to the power source, and ensures that the device can respond immediately when the user urgently needs water. Meanwhile, the requirement of the adapter power is reduced through dynamic current limiting control, so that the function of simultaneous charging and operation can be achieved by using low-cost adapters, thereby avoiding potential safety hazards caused by adapter overload.

Further, acquiring the voltage state of the lithium battery and the connection state of the external power source specifically includes:
acquiring a current terminal voltage value of the lithium battery and comparing the terminal voltage value with a preset voltage threshold range;
when the terminal voltage value is lower than a first threshold, determining that it is currently in a low-battery state, and entering a forced charging mode;
when the terminal voltage value is between the first threshold and a second threshold, determining that it is currently in a buffer state for simultaneous charging and operation, and entering a control mode that accommodates both load power supply and battery replenishment;
when the terminal voltage value is higher than the second threshold, determining that the battery has sufficient charge, pausing or reducing the charging current, and entering a voltage maintenance state;
collecting an input voltage of a power input terminal and comparing it with a reference voltage value;
when the input voltage is greater than the reference voltage value, judging that the power input is normal, and entering a charging state; and
when the input voltage is lower than the reference voltage value or a power interruption is detected, terminating a charging process, and switching to a battery powered state.

It should be noted that the terminal voltage value refers to a real-time voltage measurement value between positive and negative electrodes of the lithium battery, and it can be achieved by adopting a voltage sampling circuit combined with an analog-to-digital converter and used for reflecting current remaining capacity of the battery.

It should be noted that the preset voltage threshold range refers to multiple voltage critical points set according to the chemical characteristics of the lithium battery, for example, the first threshold can be set to 3.0V, and the second threshold can be set to 4.0V. It can be achieved by the register configuration of the main control module and used to divide different charging stages.

It should be noted that the forced charging mode refers that when the battery voltage is lower than the first threshold, the main control module preferentially controls the charging management module to charge the battery with the maximum current, while prohibiting the load power supply. It can be achieved by turning off the signal output of the drive unit.

It should be noted that the buffer state refers to a state in which the charging current and the load power supply are allowed to operate simultaneously when the battery voltage is between the first threshold and the second threshold, and it can be achieved by dynamically adjusting the charging current through the voltage division control module, such as limiting the charging current to 50% of the maximum value.

It should be noted that the input voltage comparison refers to a process where the voltage detection module collects the real-time input voltage from the external power source and compares it with the preset reference value (e.g., 4.5V), and it can be achieved by adopting a differential amplifier circuit to determine whether the external power source meets the charging requirements.

Specifically, when the terminal voltage of the lithium battery is lower than the first threshold, the main control module immediately starts the forced charging mode. At this time, the charging management module charges the battery with the maximum current, and the drive unit is forcibly closed, so as to prevent power consumption by the load. When the terminal voltage rises between the first threshold and the second threshold, the main control module switches to the buffer state, and the charging current is dynamically adjusted to a lower value. For example, the voltage at the current setting terminal of the charging management chip is adjusted by the voltage division control module, so that part of the electric energy is used to drive the load, and the remaining electric energy continues to replenish the battery. When the terminal voltage is higher than the second threshold, the charging current is gradually reduced until it stops, maintaining only a float charge state to protect the battery life. Meanwhile, the voltage at the power input terminal is continuously monitored, if the input voltage is lower than the reference value or the power interruption occurs, the main control module immediately cuts off the charging circuit and switches to the battery powered mode, thereby ensuring that the load continuously runs.

In some specific embodiments, the setting of the voltage threshold can be adjusted according to the types of the lithium batteries. For example, for lithium iron phosphate batteries, the first threshold can be set to 2.5V, and the second threshold can be set to 3.6V. The reference value of the input voltage can also be set according to adapter specifications. For example, when a 5V adapter is used, the reference value can be set to 4.75V to compensate for line loss.
regulating the charging current according to the operation mode specifically includes:
acquiring a working state signal of a drive unit, wherein the working state signal reflects whether a current load module is in an active state;
when the drive unit is detected to be in the active state, generating a first control signal to regulate a charging current control terminal of the charging management module so as to lower the charging current; and
when the drive unit is detected to be in an inactive state, generating a second control signal to switch to a maximum charging current configuration;
wherein a dynamic adjustment process of the charging current is further based on a real-time detection result of an external power supply voltage, when the external power supply voltage is lower than a preset reference value, the charging current is limited below a safety threshold.

It should be noted that the working state signal of the drive unit refers to a logic level signal used to characterize whether the load module is in an operation state. This is specifically achieved by adopting a GPIO port of a main control chip to detect a voltage state of a power supply line of the drive unit. When the voltage state of the power supply line of the drive unit is higher than a preset threshold, it is judged as the active state. The first control signal refers to an instruction signal used to reduce the charging current. This is specifically achieved by outputting the low-level to a transistor control terminal of the voltage division control module through the main control chip so as to increase the equivalent resistance of the current setting terminal of the charging management chip. The second control signal refers to an instruction signal that allows the maximum charging current. This is specifically achieved by outputting the high-level to the transistor control terminal of the voltage division control module through the main control chip so as to reduce the equivalent resistance of the current setting terminal of the charging management chip. The dynamic adjustment of the charging current refers to an operation of regulating charging powers in real time according to the voltage fluctuations of the external power source. This is specifically achieved by collecting the input voltage through the voltage detection module and feeding it back to an ADC interface of the main control chip. When the input voltage is lower than the preset threshold, the current limiting logic is triggered. The safety threshold refers to an upper limit value of the current used to prevent overloading of the power adapter. This is specifically achieved by register configuration of the charging management chip or setting of hardware voltage dividing network.

Specifically, when the drive unit is in the active state, the main control module outputs a low-level signal to the control terminal of the transistor in the voltage division control module by detecting voltage changes of the power supply line of the drive unit, so that the equivalent resistance at the current setting terminal of the charging management module is increased, thereby reducing the charging current. At this time, the power of the external power source is preferentially allocated to the load module to prevent overloading of the adapter. When the drive unit is in the deactivated state, the main control module outputs a high-level signal, so that the equivalent resistance of the current setting terminal of the charging management module is decreased, and the charging current is restored to the maximum preset value, thus to achieve rapid charging. In this process, the voltage detection module continuously monitors the input voltage of the external power source, if the input voltage is detected to be below the preset reference value, the main control module immediately intervenes to regulate the charging current below the safety threshold, preventing the power adapter from being damaged due to overload.

The above is only used to illustrate the technical scheme of the present invention rather than limitations. Those skilled in the art can make other modifications or equivalent replacements to the technical schemes of the present invention without departing from the spirits and scope of the technical schemes of the present invention, and all such modifications or equivalent replacements should be covered in the scope of the claims of the present invention.

1. A power supply control circuit for pet water dispenser, comprising: a power input module, a charging management module, a voltage division control module, a main control module, a drive unit, and a storage battery;
wherein the power input module is connected to both the charging management module and the voltage division control module, a charging current setting terminal of the charging management module is connected to ground through the voltage division control module, the charging management module is connected to both the drive unit and the storage battery, the drive unit is connected to the storage battery, and the main control module is connected to both the voltage division control module and the drive unit;
the charging management module is configured to output a charging current to the storage battery when the power input module supplies power, and control the charging current through a charging current signal output by the voltage division control module;
a control terminal of the main control module controls the charging current signal output by the voltage division control module according to working states of the drive unit.

2. The power supply control circuit according to claim 1, wherein the voltage division control module includes a resistance R3, a resistance R4, a resistance R5, a resistance R6, a resistance R7, a first switch tube and a second switch tube;
the first switch tube and the second switch tube are transistors, the power input module is connected to both a current input terminal of the first switch tube and a control terminal of the second switch tube through the resistance R3; a current output terminal of the first switch tube is connected to ground, a control terminal of the first switch tube is connected to ground through the resistance R6 and connected to the control terminal of the main control module through the resistance R7; a current output terminal of the second switch tube is connected to ground, a current input terminal of the second switch tube is connected to one end of the resistance R5, the other end of the resistance R5 is connected to the charging current setting terminal of the charging management module and connected to ground through the resistance R4; and
the control terminal of the main control module outputs a first control signal or a second control signal according to the working states of the drive unit.

3. The power supply control circuit according to claim 2, wherein the control signal is the first control signal when the drive unit is in a working state, or the second control signal when the drive unit is not in the working state; the first control signal is a high-level signal, and the second control signal is a low-level signal.

4. The power supply control circuit according to claim 1, wherein the charging management module includes a resistance R1, a charging management chip U1, and a third switch tube Q1;
the third switch tube Q1 is a MOS transistor, an enable terminal of the charging management chip U1 is connected to a gate electrode of the third switch tube Q1 through the resistance R1, a source electrode of the third switch tube Q1 is connected to a positive electrode of the storage battery and a battery positive connection terminal of the charging management chip U1, and a drain electrode of the third switch tube Q1 is connected to the drive unit.

5. The power supply control circuit according to claim 4, further comprising a display module, wherein the display module is configured to display charging states, the charging management module includes a resistance R2, and a charging state indication terminal of the charging management chip U1 is connected to the display module through the resistance R2.

6. The power supply control circuit according to claim 1, wherein the power input module includes a resistance R8, a capacitor C1, and a power input terminal VIN; the power input terminal VIN is connected to ground through the resistance R8 and the capacitor C1, respectively.

7. The power supply control circuit according to claim 1, further comprising a voltage detection module, wherein the voltage detection module is configured to collect voltages of the power input terminal VIN, and the voltage detection module includes a resistance R9, a resistance R10, and a capacitor C3;
the resistance R9 and the resistance R10 are connected in series, the resistance R9 is connected to the power input terminal VIN, and the resistance R10 is connected to ground; one terminal of the capacitor C3 is connected to a connection node VIN_AD between the resistance R9 and the resistance R10, and the other terminal is connected to ground; the connection node VIN_AD is connected to a voltage detection terminal of the main control module, the main control module is configured to judge a voltage state of the power input terminal VIN according to the voltage signal output by the voltage detection module, and control the voltage division control module so as to regulate the charging current.

8. A power supply control method for pet water dispenser, implemented with the power supply control circuit according to claim 1, comprising:
acquiring a voltage state of a storage battery and a connection state of an external power source;
judging whether it is currently in a charging mode according to the voltage state and the connection state of the external power source, and determining a corresponding operation mode, wherein the operation mode includes a load power supply priority mode or a battery charging priority mode; and
regulating a charging current according to the operation mode.

9. The power supply control method according to claim 8, wherein acquiring a voltage state of the storage battery and a connection state of an external power source specifically includes:
acquiring a current terminal voltage value of the storage battery and comparing the terminal voltage value with a preset voltage threshold range;
when the terminal voltage value is lower than a first threshold, determining that it is currently in a low-battery state, and entering a forced charging mode;
when the terminal voltage value is between the first threshold and a second threshold, determining that it is currently in a buffer state for simultaneous charging and operation, and entering a control mode that accommodates both load power supply and battery replenishment;
when the terminal voltage value is higher than the second threshold, determining that the storage battery is in a sufficient charged state, pausing or reducing the charging current, and entering a voltage maintenance state;
collecting an input voltage of a power input terminal and comparing it with a reference voltage value;
when the input voltage is greater than the reference voltage value, judging that the power input is normal, and entering a charging state; and
when the input voltage is lower than the reference voltage value or a power interruption is detected, terminating a charging process, and switching to a battery powered state.

10. The power supply control method according to claim 8, wherein regulating a charging current according to the operation mode specifically includes:
acquiring a working state signal of a drive unit, wherein the working state signal reflects whether a current load module is in an active state;
when the drive unit is detected to be in the active state, generating a first control signal to regulate a charging current control terminal of the charging management module so as to lower the charging current; and
when the drive unit is detected to be in an inactive state, generating a second control signal to switch to a maximum charging current configuration;
wherein a dynamic adjustment process of the charging current is further based on a real-time detection result of the voltage of the external power source, when the voltage of the external power source is lower than a preset reference value, the charging current is limited below a safety threshold.
